(19) United States
(12) Patent Application Publication
(10) Pub. No.: US 2010/0162709 A1
(43) Pub. Date: Jul. 1, 2010

(54) FUEL SUPPLY SYSTEM

(75) Inventor: Antony Morgan, Wolverhampton (GB)

Correspondence Address: OLIFF & BERRIDGE, PLC, P.O. BOX 320850, ALEXANDRIA, VA, 22320-4850, US

(73) Assignee: Rolls-Royce PIc, London (GB)

(21) Appl. No.: 12/676,300

(22) PCT Filed: Sep. 2, 2008
(86) PCT No.: PCT/GB2008/002958

§ 371 Date: Mar. 3, 2010

(30) Foreign Application Priority Data
Oct. 4, 2007 (GB) 0719823.7

(51) Int. Cl. F02C 7/22; G05G 9/00

(52) U.S. Cl. 60/734; 74/471 R

(57) ABSTRACT

A fuel supply system has valve communicating fuel to fuel nozzles. A fuel manifold supplies fuel to the valve. The valves are controlled by rotary drives extending from an actuator. At least part of the drive lies within the fuel manifold which serves to keep the drive cool and reduce significantly the number of seals required.

This invention relates to fuel supplies for gas turbine engines and in particular for multistage combustors of gas turbine engines.

In staged combustion a combustor is provided with a plurality of fuel injection points. A (pilot) subset of the fuel injection points supply fuel to the combustor when the turbine is operating at low power and another (main) subset of the fuel injection points supply fuel to the combustor when the turbine is operating at higher power.

Both pilot and main fuel injection points may be provided within a single fuel injector and, where this arrangement is provided, the main injection points are typically spaced radially outwardly from the pilot injection points. In an alternate arrangement the pilot fuel injection points are contained within a pilot fuel injector and the main fuel injection points are contained within a main fuel injector that is axially spaced within the combustor from the pilot fuel injector.

The pilot and main fuel injection points may be supplied with fuel from a combined circuit, discrete circuits or a combination of the two. Fuel supply branches may be used to supply a subset of fuel injection points of the main and pilot fuel injection points from the fuel supply circuits.

Fuel supply valves are controllably connected to the fuel injection circuits to permit or prevent the supply of fuel to particular ones or sets of fuel injection points.

These valves are typically positioned close to the hostile combustor or injector environment and a robust control system is desired.

It is an object of the invention to seek to provide an improved fuel supply system suitable for a turbine engine e.g. a gas turbine engine.

According to one aspect of the invention there is provided at least one valve means operable to communicate fuel to at least one fuel nozzle, a fuel manifold for communicating fuel to the at least one valve from a fuel source, and an actuator which controls the operation of the at least one valve means, the actuator being operatively connected to the at least one valve means by a flexible mechanical drive.

Preferably the flexible mechanical drive comprises a rotary cable drive. The actuator is preferably adapted to induce rotary movement into the rotary cable drive.

Preferably gearing means for providing mechanical advantage to the rotary cable drive are provided.

The fuel supply system may comprise multiple gearing means for providing mechanical advantage to the rotary cable drive.

Preferably the or one of the gearing means provides part of the valve means. The gearing means may provide a mechanical advantage of at least 20:1 to that of the actuator.

The gearing means may be adapted to distribute the drive into a plurality of flexible drive cables.

Preferably the flexible mechanical drive operatively connects the actuator to two or more valves means arranged in series. The flexible mechanical drive may be passed through a first valve to subsequent valves.

Preferably the fuel supply system comprises feedback means for determining the integrity of the flexible mechanical drive.

Preferably at least part of the flexible mechanical drive is within the fuel manifold. Even more preferably the majority of the flexible mechanical drive is within the fuel manifold.

Preferably the fuel supply system is located within a turbine engine.

According to a second aspect of the invention there is provided a fuel supply system having at least one valve operable to communicate fuel to at least one fuel nozzle, a fuel manifold for communicating fuel to the at least one valve from a fuel source, and an actuator which controls the operation of the at least one valve, the actuator being operatively connected to the at least one valve by a mechanical linkage which in use is cooled by fuel.

Preferably at least part of the mechanical linkage is within the fuel manifold. The majority of the mechanical linkage may be within the fuel manifold.

Preferably the mechanical linkage is a flexible drive.

The fuel supply system may have a plurality of fuel nozzles arranged in predetermined groupings each grouping having a respective valve, wherein the actuator and mechanical linkage are configured to control the valves such that fuel flow is enabled to one or more of the predetermined groupings of fuel nozzles and prevented to other fuel nozzles.

Embodiments of the invention will now be described by way of example only, with reference to the accompanying drawings, in which:

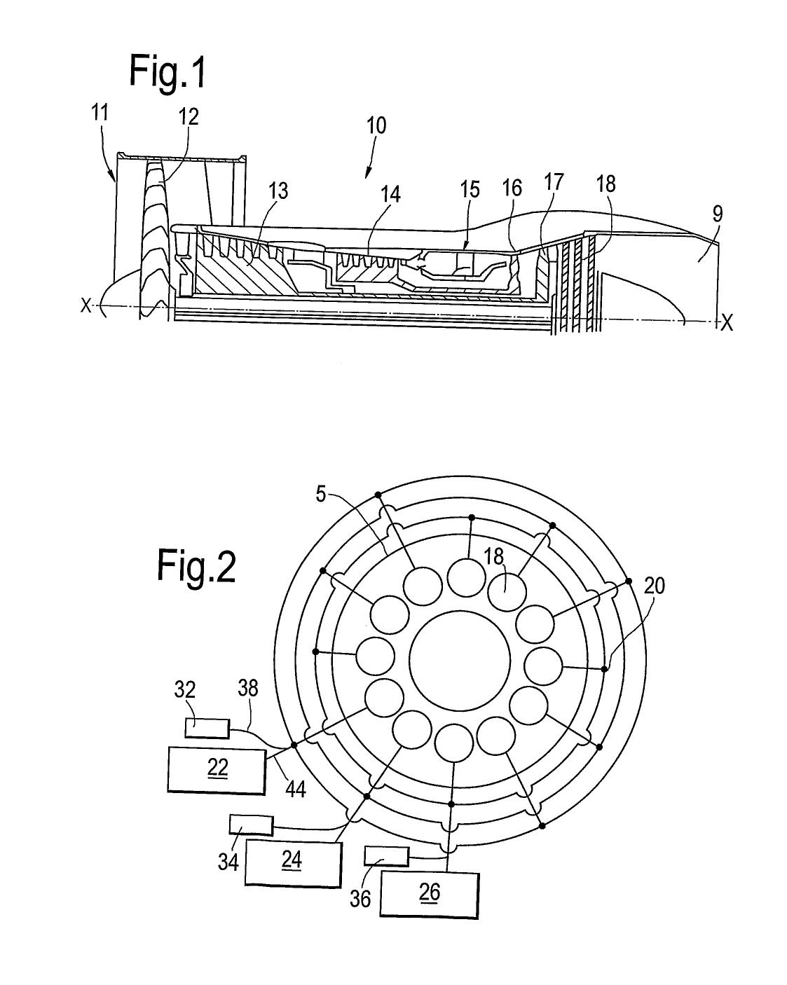

FIG. 1 depicts a section view of a gas turbine engine.

FIG. 2 depicts a first fuel supply to plurality of main injectors in a gas turbine engine.

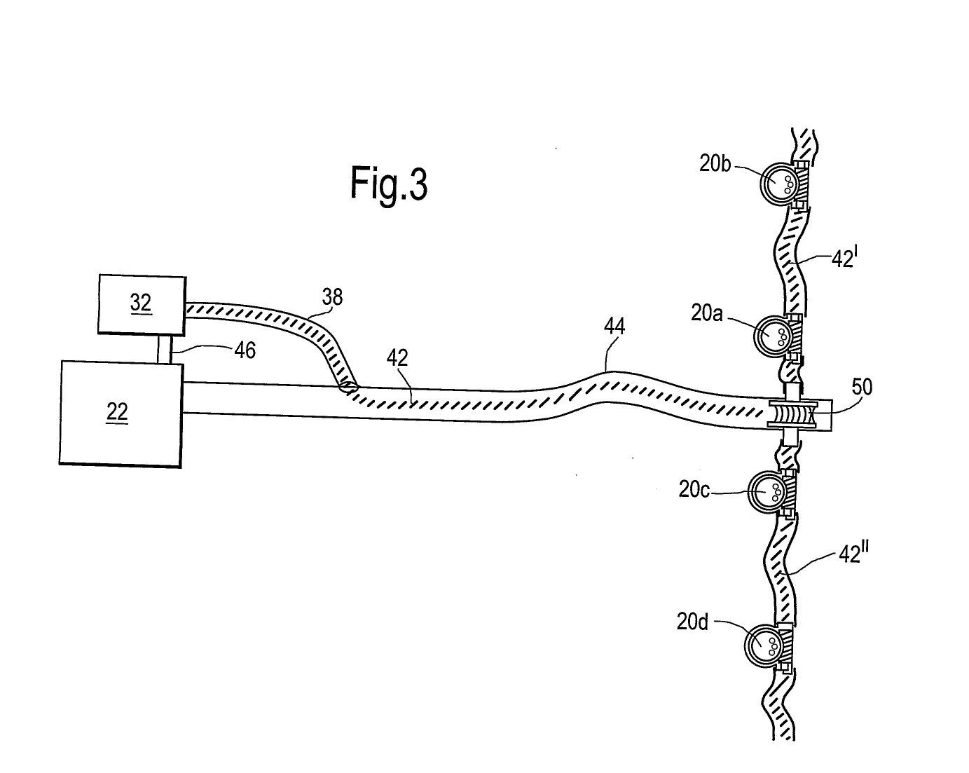

FIG. 3 depicts a control system for a first set of valves

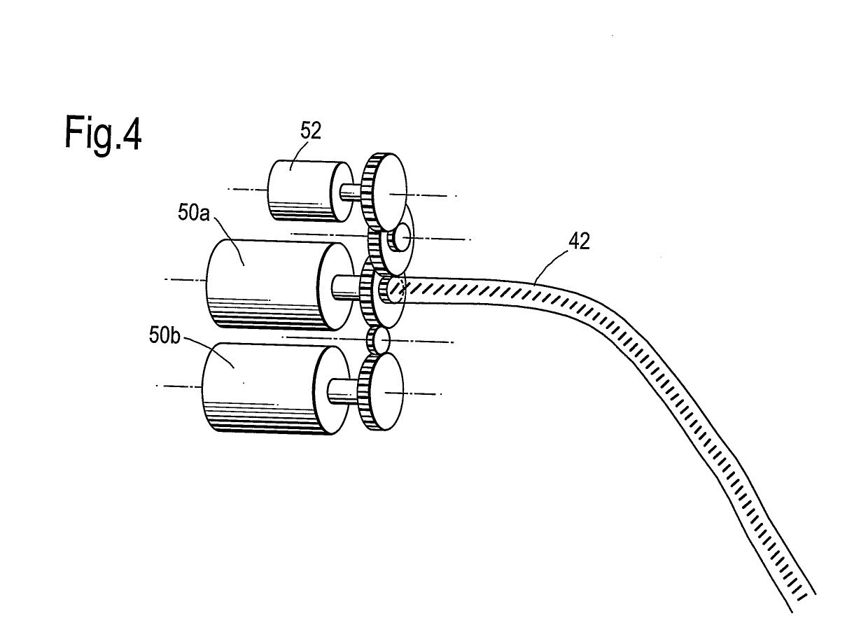

FIG. 4 depicts an exemplary prime drive actuator

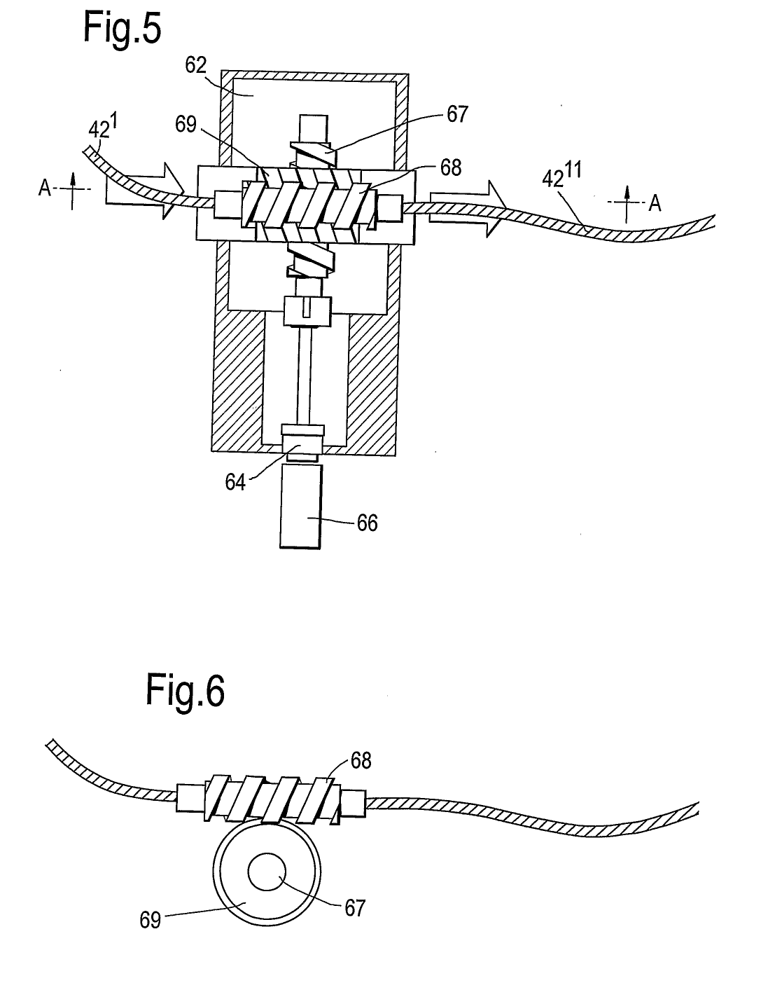

FIG. 5 depicts an exemplary control valve

FIG. 6 is a view of the drive across section A-A of FIG. 5

Further aspects and embodiments will be apparent to those skilled in the art.

With reference to FIG. 1, a ducted fan gas turbine engine generally indicated at 10 comprises, in axial flow series, an air intake 1, a propulsive fan 2, an intermediate pressure compressor 3, a high pressure compressor 4, combustion equipment 5, a high pressure turbine 6, an intermediate pressure turbine 7, a low pressure turbine 8 and an exhaust nozzle 9.

Air entering the air intake 1 is accelerated by the fan 2 to produce two air flows, a first air flow into the intermediate pressure compressor 3 and a second air flow that passes over the outer surface of the engine casing 12 and which provides propulsive thrust. The intermediate pressure compressor 3 compresses the air flow directed into it before delivering the air to the high pressure compressor 4 where further compression takes place.

Compressed air exhausted from the high pressure compressor 4 is directed into the combustion equipment 5, where it is mixed with fuel and the mixture combusted. The resultant hot combustion products expand through and thereby drive the high 6, intermediate 7 and low pressure 8 turbines before being exhausted through the nozzle 9 to provide additional propulsive thrust. The high, intermediate and low pressure turbines respectively drive the high and intermediate pressure compressors and the fan by suitable interconnecting shafts.

The combustion equipment 5 in modern gas turbines is usually an annular combustor. To meet modern efficiency and pollution targets the combustion is typically staged i.e. a different operation is required at high power requirements than required at low powers.

A number of fuel injector heads are used within an annular combustor and these are circumferentially spaced around the combustor. Each head is provided with a pilot nozzle and a main nozzle. Typically the main nozzle is radially spaced from the pilot nozzle. The nozzles may be air-blast or pressure jet or any other appropriate type. A known injector is described in U.S. Pat. No. 6,986,255, incorporated herein by reference.

A schematic of a fuel supply system in accordance with the invention is described with reference to FIGS. 2 and 3, in which the fuel supply system provides a plurality of mains fuel supply nozzles which may be grouped into one or more respective groupings, such as Mains 1 and Mains 2 and one or more pilot fuel supply nozzles for a multi-stage turbine engine.

It is possible to operate such a multi-stage engine in a variety of modes. Generally, such modes include: a pilot only mode, in which the pilot nozzles inject fuel into the combustor, but the main nozzles do not inject fuel into the combustor; a Mains 1 mode, in which a grouping of mains nozzles and the pilot nozzles inject fuel into the combustor, but the other mains nozzles groupings do not inject fuel into the combustor; and, and Mains 2 mode, in which groupings of both Mains 2 and Mains 1 nozzles and the pilot nozzles all inject fuel into the combustor. It will be appreciated that variations on these modes is possible, and whilst the present invention is described in relation to such modes by way of example, it should not be considered to be limited to operating only in such modes. Indeed the invention is equally applicable to non-staged engines.

In the embodiments described with reference to FIGS. 2 and 3 each of the twelve main nozzles 18 is provided with a respective valve 20 and the twelve main nozzles are divided into three groups of four nozzles each. For clarity the pilot nozzles and pilot fuel manifold are not shown. Whilst twelve main nozzles are depicted it will be understood that any appropriate number of nozzles may be used.

Fuel is supplied to each of the groups from a reservoir, ideally a single fuel tank, but may be, as shown here, be from separate sources 22, 24, 26.

Each valve controls the flow of fuel from the respective fuel manifold to a respective mains nozzle. The valves can be operated over a range of settings between fully open and shut-off, thereby providing control of the fuel flow rate into the combustor via these nozzles.

The range of operational settings for each valve may be a range of discrete operating positions, each position allowing a predetermined flow of fuel to be communicated to the respective fuel nozzle for a given fuel pressure. This can provide flexibility in the staging strategy and in the operation of a system in accordance with the invention.

When the valves in a given manifold are shut-off no fuel can flow through them to the mains nozzle. Thus, to avoid fuel stagnating in the manifold an optional recirculating conduit (not shown) allows fuel not communicated to the mains nozzles to be recirculated to the fuel source. Preferably, the recirculated fuel is recirculated via a flow regulating valve which may be capable of determining the recirculated fuel flow. The flow regulating valve may allow the recirculating flow to be altered e.g. by providing a variable flow restriction that enables the fuel flow to be maintained at a desired rate.

The recirculated fuel may be communicated via a surface air cooler to cool it down. The surface air cooler may form a portion of the recirculating conduit.

Provision of a recirculating conduit allows for rapid transitions between each staging mode with little or no adverse effect on engine operability. Furthermore, as a safety consideration, maintaining pressurised fuel in an un-staged fuel manifold can help to prevent air ingress into the system.

The operation of the valves is controlled by fuel staging actuators 32, 34, 36. The actuator is preferably a rotor motor drive connected to the valves via a high stiffness rotary cable 42.

With reference to FIG. 3, which shows one of the control circuits, at least part of the rotary cable is located within the fuel manifold. The actuator 32, or prime control source is located away from the fuel injector valves in what is a more benign environment.

An exemplary prime control source is depicted in FIG. 4. A pair of stepper motors 50a, 50b, one per engine controller channel, are connected together through a torque summed gearbox. Multiple engine controller channels are provided to give redundancy should one of the controllers, channels or components within the channel fail. Each stepper motor is independently capable of driving the flexible output drive. Other appropriate forms and types of drive motor, as would be considered by the person of skill in the art, may be used.

A torsionally high stiffness rotary cable 42, for example one made up of alternating layers of clockwise and counter clockwise wires is connected between the control source and the valves 20a, 20b, 20c and 20d. The wires may be formed from a variety of materials. Particularly preferred for this embodiment is either stainless steel or nimonic cables. Each cable is capable of transmitting rotary control or torque whilst allowing significant direction changes. The flexibility of the cable whilst being torsionally stiff allows considerable flexibility to the installation

The primary control source is enclosed by a container from which a conduit 38 extends and joins the main fuel supply line 44 through a Tee joint. In the embodiment shown the conduit is allowed to fill with fuel but it would be possible to have this conduit dry by providing a suitable seal at the Tee joint. Where the conduit is filled with fuel an optional drain line 46 can be provided to allow low pressure external sealing and to permit fuel circulation to prevent stagnation.

A feedback system may be provided to check the integrity of the mechanical drive cables. Feedback can either be from a geared off system at the motor end or geared off the main control loop. Simple gearing, such as a spur gearbox, may be provided to reduce the number of shaft rotations from the torque summed gearbox of the stepper motors 50a, 50b to less than one rotation at the feedback transducer. This enables, as shown in the embodiment of FIG. 4, a limited angle feedback device, such as a rotary variable displacement transducer 52 (RVDT) to be used.

The control drive cable may extend to connect directly with the valves. Alternatively, as shown in FIG. 3, a geared distribution system may be used. The geared distribution system 50 acts as a Tee, splitting the drive from the main cable into two opposing cables 42′, 42″ that each drive a subset of valves within the nozzle grouping. Thus failure of one cable still permits operation of the valves served by the remaining cable. Beneficially, the geared system may be located within a sub-chamber formed in the fuel supply manifold. The geared system allows additional ratios to be incorporated which increases the system's mechanical advantage. The potential for mechanical advantages in excess of 20:1 allows the system to be very tolerant of operating forces and frictions that the valves may produce.

The gearing can take numerous forms. A particularly preferred construction is a relatively simple worm/wheel that changes the orientation of the drive through 90° as required by the embodiment of FIG. 3. Other appropriate forms and types of gearing, as would be considered by the person of skill in the art, may be used.

A secondary benefit of the gearing is that it offers the potential for the system to be held in position when the drive is not powered. Additionally, the use of high ratio worm/wheel gearbox can advantageously result in very low backdriving efficiency.

The gearing can increase the mechanical advantage of the system such that a relatively small torque of the primary drive results in large torque/force of the drive cable at the control valves.

A duplicated geared system may be used to build in a further degree of redundancy to the system. The duplicated system permits two cables to be connected to the valves such that failure of one cable does not prevent operation of the valves and permits continued use of the system till an appropriate repair schedule can be arranged.

The cables from the prime control source, or the geared distribution system, effect adjustment of the valves either through rotary or linear movement. Where gearing is used the cables have high control stiffness and load capability.

An exemplary fuel valve that can be used within the invention is depicted in FIG. 5 and FIG. 6. The valve body 60 contains a small reservoir 62 of fuel. A valve head 64 closes a port 66 to the main injector. The valve head 64 is connected to an ACME screw 67 that is caused to translate through rotation of a gear wheel 68 effected by the flexible drive cable 42′. The screw 67 translates through a nut 69 that has a thread complementary to that of the screw on its inner surface and complementary to that of the gear wheel 68 on its outer surface. It will be understood that by careful selection of the thread angles and types further mechanical advantage can be built into the drive path from the actuator.

Translation of the screw and of the valve head 64 opens the supply of fuel to the main injector. Other appropriate forms and types of valves, as would be considered by the person of skill in the art, may be used. For example, a valve body may be used that simultaneously controls the supply of fuel to a pilot nozzle.

The drive cable passes through the valve actuator to the next valve. The cable may be continuous or, as depicted in FIG. 5, may terminate at one end of the gear wheel 68 and re-start with a new cable extending to the next valve group. The torque from the cable passing through the gear wheel 68.

It will be appreciated that modifications may be made to the system. For example, each control valve may control the supply to more than one fuel nozzle arranged in groupings. Furthermore, each valve may open and close using a different number of turns of the cable drive. In this way some valves may be open fully, while others are only partially open. This may be desirable in improving the supply options.

It will be appreciated that the invention provides a number of advantages. For example, The system allows multiple control valves to be controlled remotely from the prime control source that may be located in a more benign environment. The rotary cables do not require separate mounting offering high flexibility to system design. High stiffness control is enabled through the gearing.

The use of fuel cooling to the mechanical drive, particularly where the drive lies within the fuel conduit, means that there are no additional requirements for cooling of the drive. Fuel remains at a relatively constant temperature throughout the operating cycle which means that the drives also remain at a relatively constant temperature. Additionally, because the drive movement of the cable is through rotation, thermal expansion has negligible benefit.

In the preferred embodiments, where the drive is a high stiffness cable located within the fuel supply line, it will be appreciated that external dynamic high pressure seals are not required. These seals typically segregate high pressure fuel from potentially high ambient temperature air. Some conventional drive systems pass through these seals which have to accommodate dynamic, pressurised movement. It is difficult to make the seals leak free particularly over the whole of their life. Since the distributed control daisy chains valve mechanisms together from within the fuel manifold no, or very few, seals are required. Where seals must be used it is beneficial to locate them in more benign areas to reduce the risk of failure. The invention assists in this aim.

The rotary input at the control valves can be used in a number of ways allowing a multitude of mechanical devices to be used.

Although the system as described uses fuel as the media being distributed and subsequently controlled, the system could be similarly employed for virtually any fluid.

While the invention has been described in conjunction with the exemplary embodiments described above, many equivalent modifications and variations will be apparent to those skilled in the art when given this disclosure. Accordingly, the exemplary embodiments are considered to be illustrative and not limiting. Various changes may be made without departing from the spirit and scope of the invention.

1-16. (canceled)

17. A fuel supply system having:
at least two valve means operable to communicate fuel to at least one fuel nozzle,
a fuel manifold for communicating fuel to the at least one valve from a fuel source, and
an actuator which controls the operation of the at least one valve means, the actuator being operatively connected to two or more valves means arranged in series by means by a flexible mechanical drive.

18. A fuel supply system according to claim 17, wherein the flexible mechanical drive comprises a rotary cable drive.

19. A fuel supply system according to claim 18, wherein the actuator is adapted to induce rotary movement into the rotary cable drive.

20. A fuel supply system according to claim 19 comprising gearing means for providing mechanical advantage to the rotary cable drive.

21. A fuel supply system according to claim 19 comprising multiple gearing means for providing mechanical advantage to the rotary cable drive.

22. A fuel supply system according to claim 20, wherein the or one of the gearing means provides part of the valve means.

23. A fuel supply system according to claim 20, wherein the gearing means provides a mechanical advantage of at least 20:1 to that of the actuator.

24. A fuel supply system according to claim 20, wherein the gearing means is adapted to distribute the drive into a plurality of flexible drive cables.

25. A fuel supply system according to claim 17, wherein the flexible mechanical drive is passed through a first valve to subsequent valves.

26. A fuel supply system according to claim 17, comprising feedback means for determining the integrity of the flexible mechanical drive.

27. A fuel supply system according to claim 17, wherein at least part of the flexible mechanical drive is within the fuel manifold.

28. A fuel supply system according to claim 27, wherein the majority of the flexible mechanical drive is within the fuel manifold.

29. A gas turbine engine incorporating a fuel supply system according to claim 17.

30. A fuel supply system having:
at least one valve operable to communicate fuel to at least one fuel nozzle,
a fuel manifold for communicating fuel to the at least one valve from a fuel source, and
an actuator which controls the operation of the at least one valve, the actuator being operatively connected to the at least one valve by a mechanical linkage which in use is cooled by fuel.

31. A fuel supply system according to claim 30, wherein at least part of the mechanical linkage is within the fuel manifold.

32. A fuel supply system according to claim 30, wherein the mechanical linkage is a flexible drive.

33. A fuel supply system according to claim 17 having a plurality of fuel nozzles arranged in predetermined groupings each grouping having a respective valve, wherein the actuator and mechanical linkage are configured to control the valves such that fuel flow is enabled to one or more of the predetermined groupings of fuel nozzles and prevented to other fuel nozzles.
